(19) United States
(12) Patent Application Publication
(10) Pub. No.: US 2017/0308910 A1
(43) Pub. Date: Oct. 26, 2017

(54) INCREASING USER ENGAGEMENT VIA DETECTION OF REFRESH RATES

(71) Applicant: International Business Machines Corporation, Armonk, NY (US)

(72) Inventors: Lisa Seacat DeLuca, Baltimore, MD (US); Dana L. Price, Surf City, NC (US); Aaron J. Quirk, Cary, NC (US); Shelbee D. Smith-Eigenbrode, Thornton, CO (US)

(21) Appl. No.: 15/134,727

(22) Filed: Apr. 21, 2016

(51) Int. Cl. G06Q 30/02; H04L 12/58; G06Q 30/06; G06F 17/30; H04L 29/08; G06F 3/0485

(52) U.S. Cl. CPC G06Q 30/0201; H04L 67/22; H04L 51/04; G06F 3/0485; G06F 17/30899; G06F 17/3089; G06Q 30/0641

(57) ABSTRACT

Methods and systems may provide for detecting a user-initiated activity with respect to a view of a resource and automatically determining an update rate corresponding to the user-initiated activity. Additionally, if the update rate satisfies one or more criteria, a user prompt may be issued, wherein the user prompt includes an option to engage with the resource via a secondary interaction mode that is different from a primary interaction mode associated with the user-initiated activity.

### BACKGROUND

Embodiments generally relate to resource update management. More particularly, embodiments relate to increasing user engagement with resources via detection of refresh rates.

Conventional web browsing technology may provide for the retrieval of various pages in a browser, wherein pages displayed in the browser may be refreshed either automatically or manually. Manual refreshing, which may be implemented on certain types of web sites such as, for example, package tracking and/or banking sites, may present a number of challenges. For example, a user having elevated interest in a page (e.g., due to an impending package delivery), may refresh the page more frequently in order to obtain a status update, only to determine that there is no new information available. In such a case, the user may either continue to frequently refresh the page or leave the site altogether out of frustration. Conventional approaches may therefore result in a negative user experience as well as additional network bandwidth and/or power consumption. Indeed, the negative impact on the user experience may ultimately lead to lost customers.

### BRIEF SUMMARY

Embodiments may include a computing system comprising an activity monitor to detect a user-initiated activity with respect to a view of a resource, a rate meter communicatively coupled to the activity monitor, the rate meter to determine an update rate corresponding to the user-initiated activity, and a mode prompter communicatively coupled to the rate meter, the mode prompter to issue, if the update rate satisfies one or more criteria, a user prompt that includes an option to engage with the resource via a secondary interaction mode that is different from a primary interaction mode associated with the user-initiated activity.

Embodiments may also include a computer program product to manage resource updates, the computer program product comprising a computer readable storage medium having program instructions embodied therewith, the program instructions executable by a computer to cause the computer to detect a user-initiated activity with respect to a view of a resource, wherein the resource is to include a web page, determine an update rate corresponding to the user-initiated activity, issue, if the update rate satisfies one or more criteria, a user prompt that includes an option to engage with the resource via a secondary interaction mode that is different from a primary interaction mode associated with the user-initiated activity, detect a user acceptance of the option to engage with the resource via the secondary interaction mode, detect a state change with respect to the resource, and trigger a notification of the state change via the secondary interaction mode.

Embodiments may also include a method comprising detecting a user-initiated activity with respect to a view of a resource, wherein the resource includes a web page, determining an update rate corresponding to the user-initiated activity, issuing, if the update rate satisfies one or more criteria, a user prompt that includes an option to engage with the resource via a secondary interaction mode that is different from a primary interaction mode associated with the user-initiated activity, detecting a user acceptance of the option to engage with the resource via the secondary interaction mode, detecting a state change with respect to the resource, and triggering a notification of the state change via the secondary interaction mode.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example of a resource having multiple modes of interaction according to an embodiment;

FIG. 2 is a flowchart of an example of a method of generating user prompts according to an embodiment;

FIG. 3 is a flowchart of an example of a method of controlling interaction modes according to an embodiment;

FIG. 4 is a block diagram of an example of an engagement apparatus according to an embodiment; and

FIG. 5 is a block diagram of an example of a computing system according to an embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

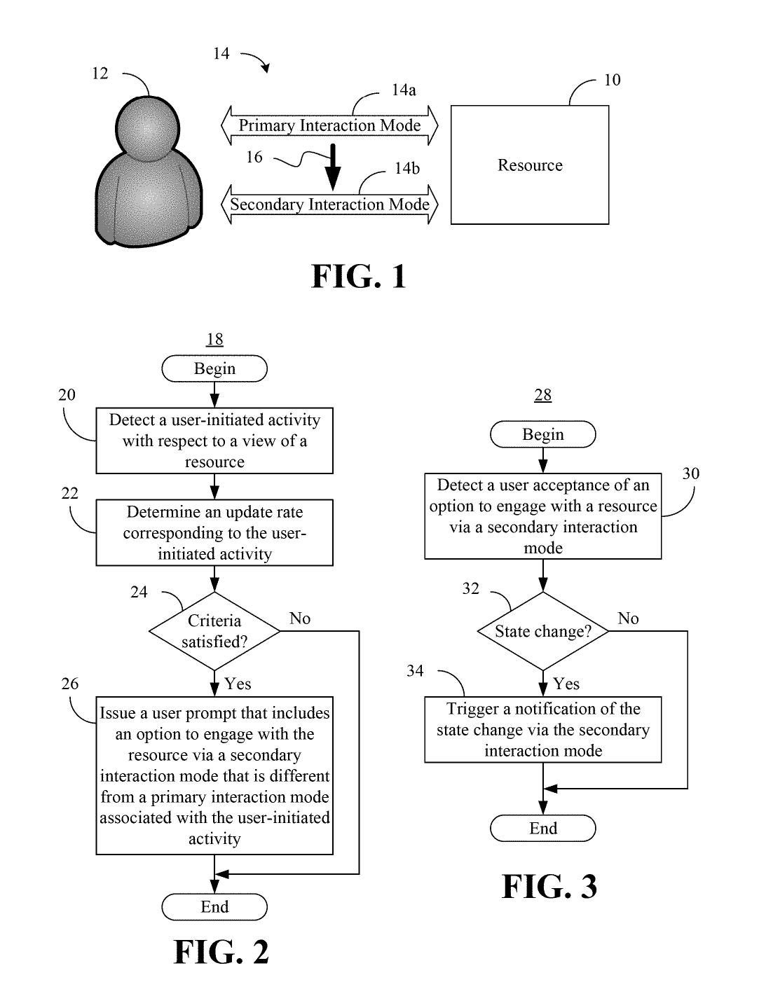

Turning now to FIG. 1, a resource 10 is shown in which a user 12 may interact with the resource 10 via a plurality of modes 14 (14a, 14b). The resource 10 might be, for example, a web page and/or site that provides a view of the status of a package delivery sequence, a bank account, a virtual machine (VM) preparation (e.g., for a cloud computing infrastructure), and so forth. In such a case, a primary interaction mode 14a may include the use of a web browser to retrieve the web page (e.g., from a remote server, not shown) and present (e.g., visually and/or audibly) the retrieved web page to the user 12.

As will be discussed in greater detail, an increased engagement between the user 12 and the resource 10 may be automatically detected based on, for example, refresh requests, scrolling activity, etc., made by the user 12 via the primary interaction mode 14a, wherein the increased engagement may generally reflect a corresponding elevation/increase in the interest of the user 12 in the resource 10. In response to the detected increase, a transition 16 may be triggered to a secondary interaction mode 14b, which may include, for example, email, instant messaging (IM), push notification, text messaging (e.g., short messaging service/SMS), phone calling, desktop notification, pop-up notification, and so forth. The secondary interaction mode 14b may therefore represent an enhanced (e.g., more responsive) engagement model that better serves the needs of the user 12. By leveraging automatically detected information regarding user interest, the illustrated transition 16 enables the user 12 to remain aware of updates to the resource 10 without continually generating refresh requests that may result in increased bandwidth and/or power consumption.

FIG. 2 shows a method 18 of generating user prompts based on user-initiated activity. The method 18 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 20 automatically detects a user-initiated activity with respect to a view of a resource. The resource may include, for example, a web page, wherein the user-initiated activity might include one or more refresh requests (e.g., user clicks on a refresh button/icon in a browser), one or more scroll requests (e.g., user “swipes” of a touch screen), and so forth. Block 20 may therefore track user behavior with respect to the view of the resource. Block 22 may determine an update rate corresponding to the user-initiated activity. The update rate may indicate, for example, the number of times the user-initiated activity occurred over a particular time span (e.g., page refresh requests per minute, screen swipes per minute, etc.). A determination may be made at block 24 as to whether the update rate satisfies one or more criteria.

The criteria might include, for example, a rate threshold being exceeded by the update rate. Thus, block 24 may compare, for example, an update rate of thirty page refresh requests per minute (30 refreshes/min) to a rate threshold of twenty page refresh requests per minute (20 refreshes/min) and determine that the rate threshold has been exceeded (e.g., 30 refreshes/min>20 refreshes/min). The rate threshold may be set and/or modified based on contextual parameters such as, for example, the time of day/year, type of package being tracked, type of bank account (e.g., savings versus trading), and so forth. Therefore, since a greater number of page refreshes might be expected during the day, the rate threshold may be increased during daylight hours. Similarly, the rate threshold might also be increased for relatively large and/or expensive products if more screen swipes are expected for those types of packages.

The criteria may also include a change threshold being exceeded by a change in the update rate. For example, block 24 may determine that the page refresh rate has suddenly increased from one page refresh request per minute (1 refresh/min) to ten page refresh requests per minute (10 refreshes/min). Therefore, if the change threshold is, for example, 5 refreshes/min², the change in the update rate (e.g., 9 refreshes/min²) would exceed the change threshold and indicate a spike in interest on the part of the user. Of particular note is that the spike in interest may be reflected in the update rate change prior to the rate threshold being exceeded. The change threshold may also be set and/or modified based on contextual parameters such as the time of day/year, type of package being tracked, type of bank account, and so forth.

If one or more of the criteria are satisfied, illustrated block 26 issues a user prompt that includes an option to engage with the resource via a secondary interaction mode that is different from the primary interaction mode (e.g., web browsing, mobile application usage) associated with the original user-initiated activity. The option to engage with the resource may include, for example, an email option (e.g., “shall we email you when there is a status change?”), an IM option (e.g., “shall we IM you when there is a status change?”), a push notification option (e.g., “shall we notify you when there is a status change?”), a text messaging option (e.g., “shall we text you when there is a status change?”), a phone call option (e.g., “shall we call you or leave you a voicemail when there is a status change?”), a desktop notification option (e.g., “shall we generate a desktop notification when there is a status change?”), a pop-up notification option (e.g., “shall we generate a browser pop-up when there is a status change?”), and so forth. If the update rate does not satisfy one or more criteria, block 26 may be bypassed and the illustrated method 18 terminates.

FIG. 3 shows a method 28 of controlling interaction modes. The method 28 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

Illustrated processing block 30 detects a user acceptance of an option to engage with a resource via a secondary interaction mode such as, for example, the secondary interaction mode 14b (FIG. 1), already discussed. Additionally, a determination may be made at block 32 as to whether a state change has occurred with respect to the resource. The state chance may be, for example, a change in the delivery status of a package, a change in a banking account balance, and so forth. If a state change is detected at block 32, a notification of the state change may be triggered at block 34 via the secondary interaction mode (e.g., email, IM, push notification, SMS, phone call, desktop notification, pop-up notification). Block 32 may also provide for modifying the criteria (e.g., rate threshold, change threshold) based on one or more contextual parameters. If no state change is detected at block 32, the illustrated method 28 bypasses block 34 and terminates.

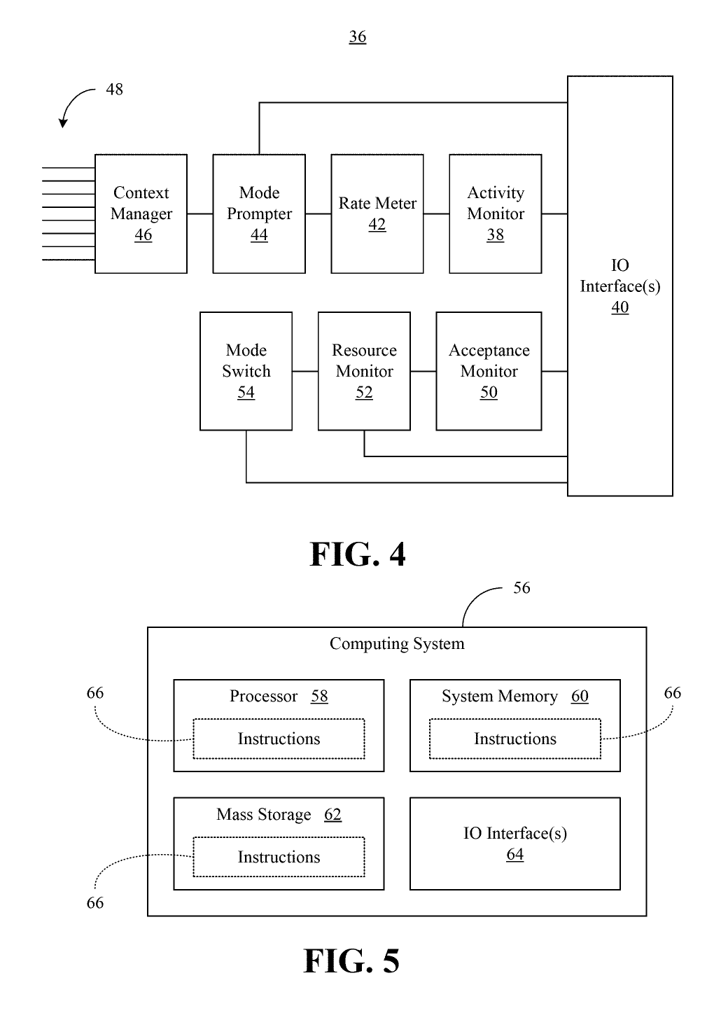

FIG. 4 shows an engagement apparatus 36 that may implement one or more aspects of the method 18 (FIG. 2) and/or the method 28 (FIG. 3), already discussed. Accordingly, the apparatus 36 may include fixed-functionality hardware, configurable logic, logic instructions, etc., or any combination thereof. The illustrated apparatus 36 includes an activity monitor 38 coupled to one or more input/output (IO) interfaces 40, wherein the one or more IO interfaces 40 may include, for example, a network controller (e.g., wireless and/or wired), a human interface device (HID, e.g., touchscreen controller), etc., or any combination thereof. The one or more IO interfaces 40 may generally support communications via Hypertext Transfer Protocol (HTTP) requests, email, IM, push notifications, SMS, phone calls, desktop notifications, pop-up notifications, and so forth. The activity monitor 38 may use a primary interaction mode to detect a user-initiated activity (e.g., refresh request, scroll request) with respect to a view of a resource (e.g., web page). Additionally, a rate meter 42 may be communicatively coupled to the activity monitor 38, wherein the rate meter 42 may determine an update rate corresponding to the user-initiated activity. The rate meter 42 may therefore include counters, converters and/or other components that transform the input from the activity monitor 38 into the update rate.

The apparatus 36 may also include a mode prompter 44 communicatively coupled to the rate meter 42 and the one or more IO interfaces 40. The mode prompter 44 may issue, if the update rate satisfies one or more criteria, a user prompt that includes an option to engage with the resource via a secondary interaction mode that is different from the primary interaction mode associated with the user initiated-activity and used by the activity monitor 38. As already noted, the one or more criteria may include, for example, a rate threshold being exceed by the update rate, a change threshold being exceed by a change in the update rate, etc., or any combination thereof. The mode prompter 44 may also be coupled to a context manager 46 that receives one or more contextual parameter inputs 48 and optionally modifies the rate threshold and/or the change threshold based on the parameter inputs 48.

Moreover, the apparatus 36 may include an acceptance monitor 50 coupled to the one or more IO interfaces 40, wherein the acceptance monitor 50 detects a user acceptance of the option to engage with the resource via the secondary interaction mode. The acceptance monitor 50 may track, for example, user activity in a browser and/or mobile application. Additionally, a resource monitor 52 communicatively coupled to the acceptance monitor 50 and the one or more IO interfaces 40 may detect a state change with respect to the resource. Accordingly, the resource monitor 52 might query one or more components and/or agents of the resource in response to a signal from the acceptance monitor 50 indicating that the engagement option has been accepted. Upon receiving confirmation that the state change has taken place, the resource monitor 52 may send a signal to a mode switch 54 to indicate that the state change has occurred. The mode switch 54 may in turn trigger a notification of the state change via the secondary interaction mode and the one or more IO interfaces 40.

Turning now to FIG. 5, a computing system 56 is shown. The computing system 56 may generally include a processor 58, system memory 60 (e.g., dynamic random access memory/DRAM), mass storage 62 (e.g., hard disk drive/HDD, optical disk, solid state drive/SSD, flash memory) and one or more IO interfaces 64 such as, for example, the 10 interfaces 40 (FIG. 4). In the illustrated example, program instructions 66 may be executed on the processor 58 in order to implement one or more aspects of the method 18 (FIG. 2) and/or the method 28 (FIG. 3), already discussed. Thus, the program instructions 66 may cause the computing system 56 to detect a user-initiated activity with respect to a view of a resource. The resource may include a web page and the user-initiated activity may include one or more of a refresh request or a scroll request. The program instructions 66 may also cause the computing system 56 to determine an update rate corresponding to the user-initiated activity.

In one example, the program instructions 66 cause the computing system 56 to issue, if the update rate satisfies one or more criteria, a user prompt that includes an option to engage with the resource via a secondary interaction mode that is different from a primary interaction mode associated with the user-initiated activity. The option to engage with the resource may include, for example, an email option, an IM option, a push notification option, a text messaging option, a phone call option, a desktop notification option, a pop-up notification option, and so forth. Moreover, the program instructions 66 may cause the computing system 56 to detect a user acceptance of the option to engage with the resource via the secondary interaction mode, detect a state change with respect to the resource, and trigger a notification of the state change via the secondary interaction mode. The program instructions 66 may also handle any authentication aspects associated with the secondary interaction mode.

The instructions 66 may include structural components that are native to the processor 58, retrieved from the system memory 60 for execution by the processor 58, retrieved from the mass storage 62 for execution by the processor 58, etc., or any combination thereof. The computing system 56 may include a server, desktop computer, notebook computer, tablet computer, convertible tablet, handheld device, media player, and so forth.

The illustrated solution may therefore enable users to focus on more important activities, rather than anxiously refreshing unchanged web pages. For example, users may close and/or leave desktop browsers, mobile browsers, etc., while remaining abreast of status changes regarding the resource. Such a solution may also eliminate superfluous system (e.g., application programming interface/API) calls that consume network bandwidth, power and backend resources.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer program product to manage resource updates, the computer program product comprising a computer readable storage medium having program instructions embodied therewith, the program instructions executable by a computer to cause the computer to:
detect a user-initiated activity with respect to a view of a resource, wherein the resource is to include a web page;
determine an update rate corresponding to the user-initiated activity;
issue, if the update rate satisfies one or more criteria, a user prompt that includes an option to engage with the resource via a secondary interaction mode that is different from a primary interaction mode associated with the user-initiated activity;
detect a user acceptance of the option to engage with the resource via the secondary interaction mode;
detect a state change with respect to the resource; and
trigger a notification of the state change via the secondary interaction mode.

2. The computer program product of claim 1, wherein the one or more criteria are to include a rate threshold being exceeded by the update rate and the program instructions are executable to cause a computer to modify the rate threshold based on one or more contextual parameters.

3. The computer program product of claim 1, wherein the user-initiated activity is to be selected from a group consisting of a refresh request and a scroll request.

4. The computer program product of claim 1, wherein the one or more criteria are to include a change threshold being exceeded by a change in the update rate and the program instructions are executable to cause a computer to modify the change threshold based on one or more contextual parameters.

5. The computer program product of claim 1, wherein the option to engage with the resource is to be selected from a group consisting of an email option, an instant messaging option, a push notification option, a text messaging option, a phone call option, a desktop notification option and a pop-up notification option.

6. A method comprising:
detecting a user-initiated activity with respect to a view of a resource, wherein the resource includes a web page;
determining an update rate corresponding to the user-initiated activity;
issuing, if the update rate satisfies one or more criteria, a user prompt that includes an option to engage with the resource via a secondary interaction mode that is different from a primary interaction mode associated with the user-initiated activity;
detecting a user acceptance of the option to engage with the resource via the secondary interaction mode;
detecting a state change with respect to the resource; and
triggering a notification of the state change via the secondary interaction mode.

7. The method of claim 6, wherein the one or more criteria include a rate threshold being exceeded by the update rate, the method further including modifying the rate threshold based on one or more contextual parameters.

8. The method of claim 6, wherein the user-initiated activity is selected from a group consisting of a refresh request and a scroll request.

9. The method of claim 6, wherein the one or more criteria include a change threshold being exceeded by a change in the update rate, the method further including modifying the change threshold based on one or more contextual parameters.

10. The method of claim 6, wherein the option to engage with the resource is selected from a group consisting of an email option, an instant messaging option, a push notification option, a text messaging option, a phone call option, a desktop notification option and a pop-up notification option.

11. A computing system comprising:
an activity monitor to detect a user-initiated activity with respect to a view of a resource;
a rate meter communicatively coupled to the activity monitor, the rate meter to determine an update rate corresponding to the user-initiated activity; and
a mode prompter communicatively coupled to the rate meter, the mode prompter to issue, if the update rate satisfies one or more criteria, a user prompt that includes an option to engage with the resource via a secondary interaction mode that is different from a primary interaction mode associated with the user-initiated activity.

12. The computing system of claim 11, further including:
an acceptance monitor to detect a user acceptance of the option to engage with the resource via the secondary interaction mode;
a resource monitor communicatively coupled to the acceptance monitor, the resource monitor to detect a state change with respect to the resource; and
a mode switch communicatively coupled to the resource monitor, the mode switch to trigger a notification of the state change via the secondary interaction mode.

13. The computing system of claim 11, wherein the one or more criteria are to include a rate threshold being exceeded by the update rate.

14. The computing system of claim 13, further including a context manager communicatively coupled to the mode prompter, the context manager to modify the rate threshold based on one or more contextual parameters.

15. The computing system of claim 11, wherein the one or more criteria are to include a change threshold being exceeded by a change in the update rate.

16. The computing system of claim 15, further including a context manager communicatively coupled to the mode prompter, the context manager to modify the change threshold based on one or more contextual parameters.

17. The computing system of claim 11, wherein the user-initiated activity is to include a refresh request.

18. The computing system of claim 11, wherein the user-initiated activity is to include a scroll request.

19. The computing system of claim 11, wherein the resource is to include a web page.

20. The computing system of claim 11, wherein the option to engage with the resource is to be selected from a group consisting of an email option, an instant messaging option, a push notification option, a text messaging option, a phone call option, a desktop notification option and a pop-up notification option.
